(19) United States
(12) Patent Application Publication
(10) Pub. No.: US 2008/0245889 A1
(43) Pub. Date: Oct. 9, 2008

(54) Container with air freshener

(75) Inventors: Victor Klabbers, Brussels (BE); Steven Anthony Horenziak, Cincinnati, OH (US); Arthur Bryon Stackpole, Mason, OH (US); Susan Clare Robinson, Ixelles (Brussels) (BE)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company

(21) Appl. No.: 11/732,775

(22) Filed: Apr. 4, 2007

(51) Int. Cl. A24F 25/00; B05B 15/00

(52) U.S. Cl. 239/55; 239/289

(57) ABSTRACT

The present invention relates to a combined dispensing container and air freshener comprising: (1) a container body comprising a detergent composition to be dispensed; (2) a container closure; and (3) an air freshening unit permanently attached to the container body and having a fixed volume above 45 ml; to provide detergent usage and improved passive air freshening performance and improved fragrance burst while shaking.

### FIELD OF THE INVENTION

The present invention relates to the combination of a detergent container and an air freshener for detergent use and immediate and long lasting air treatment.

### BACKGROUND OF THE INVENTION

Air fresheners are frequently used to control odors in bathrooms, kitchens and other enclosed spaces. Generally commercial dispensers for dispensing fragrances or air-freshening materials operate in an active mode or passive mode. Active dispensing is achieved by way of an aerosol or pump activated spray dispenser. In addition to such dispensers, which require an action on the part of the consumer to result in the immediate dispensing of the dispersible composition, dispensers which operates passively, through evaporation or sublimation of vaporizable substances, without active physical participation by the consumers, are also well known. Active dispensing provides an immediate and intense air treatment whereas passive dispensing provides a continuous effect to the atmosphere over extended time periods at a slow release rate. Dual dispensers working on the active and passive mode have been described in the art. Please refer for example to WO01/10739 published by S.C. Johnson & Son Inc. on Feb. 15, 2001 which discloses dual functional dispensers comprising dispensing units independently capable of dispensing an actively dispersed spray or an evaporating long term dispersible material.

It is also known in the art to combine an air freshener with a hand lotion or a soap. WO02/20172 published by Fresh Product on Mar. 14, 2002 discloses a combined unit wherein the air freshener may be passively dispersed at a controlled rate or actively dispersed when a user pumps the apparatus to receive a measured quantity of hand lotion. Dispersion may be implemented using a mechanical fan or compression of a sponge.

Indeed, containers of cleaning products such as dishwashing detergent are left on countertops since they are in constant use through a day. Such containers can provide a dual purpose. By combining an air freshener and a container for detergent, especially a hand dishwashing detergent, the air in the kitchen can be freshened to remove cooking or other odors or simply to add a pleasant fragrance to the air. WO2004/084954 published by Colgate Palmolive on Oct. 7, 2004 describes a container for household product with, as a part of its structure, a passive delivery system for room freshening fragrance. Associated with an upper portion of the container is a tray unit with a plurality of separate compartments containing the same of a different fragrance. Each compartment can be opened separately as a way to control the amount of delivery of the air freshener to a room. The fragrance emitting dispensing container described in WO2004/084660 published by Colgate Palmolive on Oct. 7, 2004; is located in the closure. However, these prior art products provide only a continuous passive effect over a long time at a slow release rate.

Indeed, most retail, or consumer-oriented, air fresheners operate on an “always on” basis. That is, once the air freshener is initially activated, it dispenses fragrance until its supply is exhausted. Because air freshening is typically only necessary when a person is in the same general area as the air freshener dispenser, the “always on” dispensers may result in a majority of the fragrance being dispensed when it is not necessary or desired. More user oriented consumer air fresheners are available, such as spray-type products, for example. However, the necessary mechanisms to propel the air freshener often make spray type dispensers relatively expensive and difficult to recycle and not always suitable for use in the kitchen.

The present invention provides a combined detergent/air freshener dispenser which is able to provide in a highly simple and cost effective manner both an active burst of fragrance in the air and a passive dispensing of the same material by evaporation over an extended period of time in an environment where the detergent composition is stored and/or used. When needed or desired, the consumer can obtain an immediate and intense air treatment, in addition to the continuous air freshening effect when the consumer dispenses the detergent for use or simply shakes the dispenser. To obtain such benefit, the air freshening unit of the combined dispenser of the present invention is characterized by a fixed volume of above 45 ml.

Without being bound by theory, it is believed that while resting, the fragrance is concentrating in the air of the air freshener headspace. When shaken, the headspace is cleared and this provides an effective and highly pleasant burst of the fragrance. It has been found that such fragrances' burst is obtained when sufficient fragrance has been building up in the headspace. This requires a volume of the air freshener unit of at least 45 ml. Furthermore, it has been surprisingly found that a venting area above 4 cm2, provides further improved passive performance and improved fragrance burst while shaking.

### SUMMARY OF THE INVENTION

The present invention relates to a combined dispensing container and air freshener [also referred hereinafter as “device”] comprising: (1) a container body comprising a detergent composition to be dispensed; (2) a container closure; and (3) an air freshening unit permanently attached to the container body and having a fixed volume of above 45 ml.

The present invention also relates to a method to provide an immediate and intense air treatment by shaking said combined dispensing container and air freshener. In a preferred embodiment such immediate and intense air treatment is obtained when the detergent is dispensed from the device.

### BRIEF DESCRIPTION OF THE FIGURES

FIG. 1 illustrates a front view of a combined dispensing container and air freshener.

FIG. 2 illustrates a perspective view of a combined dispensing container and air freshener.

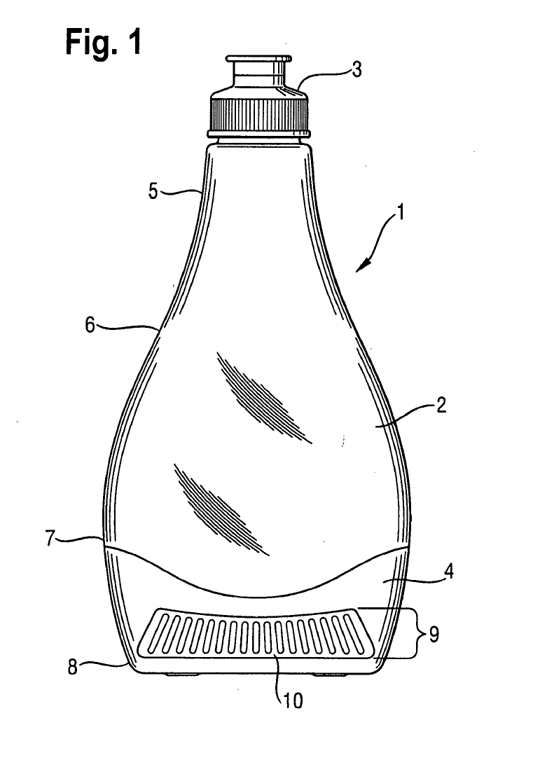

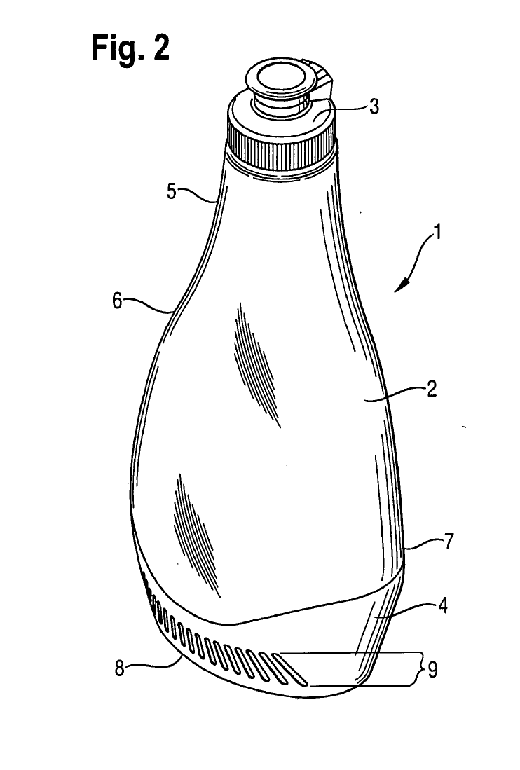

The preferred embodiment of the invention is disclosed in more detail in reference to FIG. 1 and FIG. 2. FIG. 1 depicts: A combined dispensing container and air freshener (1) comprises a container body (2), a flip-top cap as a closure (3) and an air freshening unit (4). The container body has a neck (5) and a grip area (6) preferably a squeeze area and a base (7). The air freshener unit (4) is attached to the base (7) of the container body (2) via for example groove(s). The air freshener (4) has a base (8) and a venting area (9). Such venting area is closed by a removable sticker (10). FIG. 2 depicts the same combined dispensing container and air freshener (1) in a perspective view wherein the removable sticker on the venting area (9) has been removed.

### DETAILED DESCRIPTION OF THE INVENTION

While the description which follows frequently refers to an air freshener or fragrancing application, it is to be understood that the invention is also applicable to other forms of dispersible materials which may be dispensed passively such as deodorizers, odor eliminators, malodor counteractants, insecticides, insect repellant, medicinal substances, disinfectants, sanitizers, mood enhancers, and aroma therapy compositions.

For purposes of the present invention, active dispensers shall be those which require an action on the part of the consumer to dispense a dispersible composition, which is dispersed as a burst or spray, as a direct result of the action of the consumer, while passive dispensers shall be those which require no action by the consumer at the time that the dispersible is dispensed, but dispense a dispersible by evaporation, sublimation, or the like, over a period of time, at a relatively low rate when compared to the rate of an active dispenser. Removal of a cover, wrapping, or control means from a passive dispenser is not to be considered an action to dispense the composition.

A pourable detergent composition, preferably a liquid detergent composition, is held within the container and is dispensible from the container by pouring or squeezing the detergent composition. Such detergent composition is typically selected from the group of a dishwashing composition, a laundry composition, and/or a hard surface cleaning composition, and preferably is a hand dishwashing composition. Such detergent composition usually includes a surfactant system, and typically a solvent, and one or more optional ingredients known in the art of cleaning such as a dye, an enzyme, a perfume, a thickener, a pH controlling agent, a reducing or oxidizing bleach, an odor control agent, antioxidants and free radical inhibitors, and a mixture thereof.

### Container

The container body and closure can be of any material including glass, but plastics are preferred and in particular plastic that can be injection molded or blowmolded. These include polyolefins such as polypropylene and polyesters such as polyethylene terephtalate.

Any shape can be used for the container body of the present invention and will typically comprise a neck closed by a closure, a grip area, preferably a squeeze area and a base. The neck can be closed by any cap, preferably a flip-top cap or pull and push cap, more preferably a flip-top cap.

### Air Freshener (AF) Unit

The AF unit is permanently attached to the container body. It can be produced separately and then fixed to the container body via for example a clip-on system or can be produced simultaneously with the container body. Preferably the AF unit does not from part of the container closure. Preferably, the AF unit is located at the bottom of the container body and forms the base of the device.

The AF unit has a fixed volume of above 45 ml, preferably above 50 ml, more preferably above 60 ml, and even more preferably above 70 ml. Preferably, the AF unit has a fixed volume below 250 ml, more preferably below 150 ml and even more preferably below 120 ml. The volume of the AF unit is the volume of the AF unit per se, including the venting openings but excluding any air freshening material.

The air freshening unit must be constructed such as to ensure that the fragrance can diffuse outside. The AF unit can therefore be made of a material which is, as such, permeable to perfumes, for instance low density polyethylene. However, in that embodiment perfume migration through the material may be slow and more difficult to control, so that in a preferred embodiment the AF unit is made of any plastic, and comprises openings also referred to as vents, allowing communication of the fragrance from the AF unit headspace to the outside environment. These opening(s) or vent(s) form all together the venting area and can be in whatever shape and orientation: horizontal or vertical, wave(s), line(s), circle(s) or other shapes. In the instance the air freshener is in the form of perfume particles, such vents are smaller than the smaller perfume particles contained in the air freshening unit.

In a preferred embodiment, the AF unit has a venting area above 4 cm², preferably above 5 cm², more preferably above 6 cm², even more preferably above 7 cm². Preferably, the AF unit has a venting area lower than 30 cm², more preferably lower than 20 cm², even more preferably lower than 15 cm².

Before use, the venting area of the AF unit will be sealed with any means such as with removable sticker(s) or shrink sleeve. Such seal can be in one or more pieces so as to allow the adjustment of the air freshener's release by e.g. removing one, several or all stickers.

### Air Freshener Composition

Typically, an ingredient suitable for inclusion in the air freshener unit is a fragrance, air freshener, deodorizer, odor eliminator, malodor counteractant, insecticide, insect repellant, medicinal substance, disinfectant, sanitizer, mood enhancer, aroma therapy composition, or the like, in solid, liquid or gel form. Preferably, the fragrance or air freshener is a fragrance comprising one or more volatile organic compounds which are available from perfumery suppliers such as Firmenich Inc., Takasago Inc., Noville Inc., Quest Co., International Flavors & Fragrances, and Givaudan-Roure Corp. Most conventional fragrance materials are volatile essential oils. The fragrance can be a synthetically formed material, or a naturally derived oil such as oil of Bergamot, Bitter Orange, Lemon, Mandarin, Caraway, Cedar Leaf, Clove Leaf, Cedar Wood, Geranium, Lavender, Orange, Origanum, Petitgrain, White Cedar, Patchouli, Lavandin, Neroli, Rose absolute, and the like.

A wide variety of chemicals are known for perfumery, such as aldehydes, ketones, esters, alcohols, terpenes, and the like. A fragrance can be relatively simple in composition, or can be a complex mixture of natural and synthetic chemical components. Synthetic types of fragrance compositions either alone or in combination with natural oils are described in U.S. Pat. No. 4,324,915 describing novel ketoamines and their use in processes to prepare cyclorpropanecarboxylic acid pyrethroid intermediates; U.S. Pat. No. 4,411,829 describing methyl 2,6,6-trimethyl-cyclohex-2-en-1-yl carboxylate for the reproduction of fruity, floral and fresh odor notes; and U.S. Pat. No. 4,434,306 describing perfume compositions based on bicyclol[2,2,2]octane and bicycle[2,2,2]octenes derivatives for a sandalwood oil-like odor; incorporated herein by reference. Other artificial liquid fragrances include geraniol, geranyl acetate, eugenol, isoeugenol, linalool, linalyl acetate, phenethyl alcohol, methyl ethyl ketone, methylionone, isobomyl acetate, and the like.

A liquid fragrance may also be formed into a thixotropic gel by the addition of a thickening agent, such as a cellulosic material, a polymeric thickener, or a fumed silica of the type marketed under the Cabosil trademark by Cabot Corporation. A fragrance ingredient can also be in the form of a crystalline solid, which has the ability to sublime into the vapor phase at ambient temperatures. A crystalline fragrance starting material can be selected from organic compounds which include vanillin, ethyl vanillin, coumarin, tonalid, calone, heliotropene, musk xylol, cedrol, musk ketone benzophenone, raspberry ketone, methyl naphthyl ketone beta, phenyl ethyl salicylate, veltol, maltol, maple lactone, proeugenol acetate, evemyl, and the like. This type of fragrance can contribute a long term air-treatment capability to an air freshener dispenser device for use in the present invention.

In a preferred embodiment, the air freshener composition is in the form of perfumed particles which emit their perfume gradually over time. Particles suitable for use herein may be made of polymers, or clay, or porous rocks or stones such as pumice, silica or silicates.

Suitable for use herein are polymeric particles such as those which have been disclosed and exemplified in: WO9947182 on pages 16, line 1 to page 22, line 16: foamed or non-foamed low density polyethylene, high density polyethylene, polypropylene, the copolymer of ethylene and vinyl acetate and polyvinyl chloride, more specifically the copolymers of ethylene and a polar vinyl monomer selected from vinyl acetate, ethyl acrylate, methyl acrylate, butyl acrylate and acrylic acid; U.S. Pat. No. 4,095,031: describes as well copolymers of ethylene and 6-6 wt % of a polar vinyl monomer selected from vinyl acetate, ethyl acrylate, methyl acrylate, butyl acrylate and acrylic acid; U.S. Pat. No. 3,505,432: describes in Col. 4, line 8-64 a method for producing scented polyethylene and polypropylene; U.S. Pat. No. 4,247,498: describes Col. 6, lines 28-45 a method to produce microporous polymers products characterized by relative homogeneity and narrow pore size distribution; U.S. Pat. No. 4,156,067: polyurethane polymers with a MW above 6,000 and lactone groups and hydroxyl groups in the polymer backbone as a support for alcohols and esters; U.S. Pat. No. 4,521,541 and U.S. Pat. No. 4,542,162: describe the production of thermoplastic polymeric foamed particles as controlled release compositions for perfumes by suing a single screw or a twin screw extruder and placing the resin, functional fluid or solid and gaseous or liquid blowing agent into the extruder stream at specific ranges of lateral intervals; U.S. Pat. No. 5,543,398: describes para-C5 alkyl-substituted ethoxycyclohexanes to enhance the aroma of perfume compositions (Col. 12, lines 20-46); U.S. Pat. No. 6,379,689 discloses a carrier based on a silicone elastomer matrix in which is dispersed the volatile substance (Col. 1, lines 39-62); all incorporated herein by reference.

Preffered polymeric carriers for use in the present invention are low density polyethylene or ethylene vinyl acetate, preferably ethylene vinyl acetate. Please refer for example to U.S. Pat. No. 4,761,437 which discloses a process for producing a fragrance chip by absorbing liquid fragrance on ethylene vinyl acetate; U.S. Pat. No. 4,515,909 describes resinous composition for fragrance comprising at least 1 specific ethylene vinyl acetate copolymer and a diffusing agent being benzyl benzoate, benzyl salicylate and/or di-(loweralkyl)phthalate (Col. 3, line 6 to Col. 4, line 26); U.S. Pat. No. 4,492,644 discloses a slowly releasing perfume composition made from granulated ethylene vinyl acetate copolymer and a perfume which contains hydrocarbons and/or esters, at a temperature from 10-50° C. (Col. 2, line 14 to Col. 3, line 30); and U.S. Pat. No. 4,511,496 discloses a process whereby a pellet of ethylene vinyl acetate copolymer and a perfume are mixed and when the perfume has been impregnated only the surface layer of the pellet, a fine powder as a coating (Col. 1, line 54 to Col. 3, line 49); all incorporated herein by reference.

Suitable perfumed particles for use herein are commercially available from International Flavors and Fragrances (IFF) under the trade-name Polyiff. Such particles are available as both low density polyethylene and as ethylene vinyl acetate (EVA) and are preferably the EVA form.

Simply stated, the process for making such particles involves mixing a molten plastic with the perfume, and allowing the mix to solidify in the appropriate shape.

Perfume loading of the particles can vary within broad ranges, depending on the particular demands for a particular device on the perfume composition and perfume carrier. Particles herein typically carry between 2%-75%, preferably 5%-60%, more preferably 5%-35% by weight of perfume, and the total weight of the particles may represent from 5 grams to 40 grams. In a preferred embodiment, the perfume loading of the perfume material and the amount of perfume material will be adjusted to match the longevity of the detergent composition when used at a regular dosage during a normal use by a normal consumer.

Preferably, there is enough free space remaining in the AF unit so that perfume particles are free to move when the dispenser is shaken and/or used to dispense the liquid, so as to improve the duration and linearity of the release of the perfume, which at a certain point becomes hindered if too many particles are present.

It has also been found that the perfumes particles ideally should not impede air flow through the venting area. Particles stacked over the vent area have the effect of lowering the vent area. Preferably less than 50%, more preferably less than 25% of the vent area should be obstructed to provide the desired passive and active experience.

The particles herein are preferably substantially spherical, as opposed to rods or square or rectangular blocks. Indeed, when spherical, the particles have increased mobility inside the device, so that fresh and clean surfaces of the particles are exposed over time. The population of particles can be substantially homogeneous in terms of their perfume content, but it can be attractive to have a heterogeneous population. Indeed, certain particles comprising certain perfumes can be manufactured as homogeneous populations, in batches, and then the different populations can be mixed together in an infinity of variations, offering an economically attractive flexibility in the choice of perfumes and functionality. Indeed, perfumes can be used which will additionally provide sanitisation and/or antibacterial benefits.

Preferably the fragrance of the air freshener will be coordinated or will be the same as the perfume accord of the detergent composition. Preferably the air freshener will be the same as or will match the color or color shade of the detergent composition.

### The Process

In the process according to the present invention, the combined dispensing container and air freshener described above is placed on a countertop or in an enclosed space such as a storage cupboard, preferably on a countertop, as in a kitchen or cellar, preferably in a kitchen. The seal on the AF unit is partially or completely removed so as to provide the passive continuous refreshening of the surrounding air. When needed to disregard cooking odors or malodors rising within an enclosed space, or when desired, the combined dispensing container and air freshener can be shaken to provide an immediate and substantial dispensing or the air freshener. When the detergent composition is dispensed from the combined dispensing container and air freshener for use, an immediate, intense and highly pleasant air treatment will be obtained as well.

### Device With Usage Instructions

In another embodiment of the present invention, the device described herein above is provided together with usage instructions to use it in a process described hereinabove, so as to make the best possible use of the device's unique advantages. In that embodiment, a product is provided that comprises the combined dispensing container and air freshener and usage instructions to place said device inside an environment which requires both active and passive air freshening such as in a storage cupboard or on a kitchen countertop and to shake said device to provide an immediate and increased air freshener release.

In another embodiment of the present invention, liquid detergent composition is provided separately from the device as described hereinabove, as refills for the dispensing container of said device.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A combined dispensing container and air freshener comprising:
(1) a container body comprising a detergent composition;
(2) a container closure;
(3) an air freshening unit permanently attached to the container body and having a fixed volume above 45 ml.

2. The combined dispensing container and air freshener of claim 1 wherein the air freshening unit has a fixed volume of above 50 ml.

3. The combined dispensing container and air freshener of claim 1 wherein the air freshening unit has a fixed volume below 250 ml.

4. The combined dispensing container and air freshener of claim 1 wherein the air freshener unit is further characterized by venting area above 4 cm².

5. The combined dispensing container and air freshener of claim 4 wherein the air freshener unit has a venting area lower than 30 cm².

6. The combined dispensing container and air freshener according to claim 1 wherein the air freshening unit does not from part of the container closure.

7. The combined dispensing container and air freshener according to claim 1 wherein the air freshening unit is located at the bottom of the container body.

8. The combined dispensing container and air freshener according to claim 1 wherein the air freshening unit comprise air freshener in form of perfume particles.

9. The combined dispensing container and air freshener according to claim 1 wherein the detergent composition is a hand dishwashing composition.

10. A method to provide an immediate burst of fragrance by shaking the combined dispensing container and air freshener according to claim 1.

11. The method according to claim 10, wherein the shaking is achieved when dispensing the detergent composition.

12. A product comprising the combined dispensing container and air freshener of claim 1 and usage instructions to place said combined dispensing container and air freshener inside an environment which requires both active and passive air freshening such as in a storage cupboard or on a kitchen countertop and to shake said device to provide an immediate and increased air freshener release.
